(19) United States
(12) Patent Application Publication
(10) Pub. No.: US 2024/0327263 A1
(43) Pub. Date: Oct. 3, 2024

(54) SYSTEM FOR BIOLOGICAL PHOSPHORUS AND NITROGEN REMOVAL IN AN ACTIVATED SLUDGE PROCESS

(71) Applicant: DENTRO-P, LLC, Yakima, WA (US)

(72) Inventor: Thomas E. Coleman, Yakima, WA (US)

(21) Appl. No.: 18/621,033

(22) Filed: Mar. 28, 2024

Related U.S. Application Data
(60) Provisional application No. 63/455,537, filed on Mar. 29, 2023.
(60) Provisional application No. 63/464,391, filed on May 5, 2023.

(51) Int. Cl. C02F 3/30; C02F 3/00; C02F 101/10; C02F 101/16

(52) U.S. Cl. CPC C02F 3/301; C02F 3/006; C02F 3/302; C02F 3/308; C02F 2101/105; C02F 2101/163; C02F 2101/166; C02F 2201/005; C02F 2209/005; C02F 2209/04; C02F 2301/046

(57) ABSTRACT

A system for processing municipal and industrial wastewater utilizing activated sludge treatment, particularly configured to employ enhanced biological phosphorus removal, along with nitrification and denitrification, and utilizing compartmentalized activated sludge process treatment tanks in a continuous flow activated sludge process. The processing system improves the performance and efficiency in the treatment of municipal and industrial wastewater to remove phosphorus and nitrogen, and can be incorporated into existing or new “activated sludge wastewater” (ASW) treatment systems.

### TECHNICAL FIELD

The present disclosure relates to and is applicable to the processing of municipal and industrial wastewater in an activated sludge treatment process. It is particularly applicable to activated sludge treatment systems configured to employ enhanced biological phosphorus removal, along with nitrification and denitrification, utilizing compartmentalized activated sludge process treatment tanks. The herein disclosed processing system improves the performance and efficiency in the treatment of municipal and industrial wastewater to remove phosphorus and nitrogen, and can be incorporated into existing or new “activated sludge wastewater” (ASW) treatment systems.

### BACKGROUND OF THE INVENTION

“Biological nutrient removal” (BNR) through improved methods employing “nitrification and denitrification” (NdN), and by “enhanced biological phosphorus removal” (EBPR) processes have gained widespread acceptance for the treatment of wastewater. These biologically based methods and are generally preferable to physical-chemical treatment alternatives because of cost and sustainability considerations, while imparting a lower carbon footprint with less greenhouse gas emissions due to reduced chemical use and lower energy needs.

Anoxic zones in wastewater treatment systems are useful for nitrogen removal. Some wastewater has a high nitrate and nitrite content, and a primary goal of a treatment process is to break down nitrogen containing oxides, to avoid causing nutrient pollution when the plant discharges its effluent back into the environment. In anoxic zones certain bacteria can break down the nitrogen-oxygen compounds and the separation of these molecules releases oxygen, which the bacteria need to thrive.

For most wastewater treatment systems, anaerobic respiration is a desired process using certain bacteria that can survive and thrive in the absence of any oxygen. During anaerobic processes, both free and bound oxygen are typically absent. Nitrates and nitrites do not usually exist in wastewater processes that utilize anaerobic bacteria to process influent waste. These conditions differ from anoxic environments, in which free oxygen is absent but bound oxygen as found in nitrates and nitrites may be present.

During anaerobic wastewater treatment processes, microorganisms break down waste matter in the absence of oxygen. These processes often occur in an enclosed bioreactor filled with sludge. The sludge contains anaerobic bacteria and other beneficial microbes. In the bioreactor, the microorganisms digest the organic matter in sludge.

Aerobic wastewater treatment often uses equipment like surface aerators or diffusers to mix air into the water column. With surface aerators, the mechanical churning on the surface mixes oxygen into the wastewater. With diffusers, the bubbles of air that rise from the bottom of the tank facilitate oxygen transfer. The presence of oxygen stimulates beneficial oxygen-feeding bacteria, protozoa, and other microbes in the water to help treat the waste by breaking down organic matter.

The activated sludge process uses an aeration tank with aerators or diffusers. As the organic material in the waste breaks down, it typically forms large bacterial communities known as flocculent activated sludge or simply “flocs”. The flocs settle to the bottom of the tank or reactor, where they are easy to remove. Wastewater treatment plants may then return some of the settled activated sludge back into the upstream treatment tanks so the bacteria can aid in treatment process.

An example of conventional wastewater treatment system that employs anaerobic, anoxic, and aerobic processes elements for “nitrogen” (N) and “phosphorus” (P) removal is shown as prior art in FIG. 1 in a schematic process flow diagram with a conventional wastewater treatment system that includes “activated sludge wastewater treatment” (ASWT) 21 employing a biological nutrient removal 22, which include the processes of EBPR 23 and NdN 24 as discussed above, for treating an activated sludge 25. Specifically, in an aerobic zone 32 within the ASWT process, the ammonia present in a wastewater influent 28 is oxidized by autotrophic bacteria in the NdN process to nitrate, and phosphates in the wastewater influent are removed by “polyphosphate accumulating organisms” (PAOs) in the EBPR process.

The basic engineering principles for the design of P and N removal treatment facilities have been well established and have been implemented in various configurations including the UCT process, the Bardenpho process, the A₂O process, and others well known to those skilled in wastewater treatment systems. FIG. 2 diagrams the established, prior art process of biological phosphorus removal, as referenced in an U.S. EPA nutrient control design manual by Smolders G J, et al., titled: “Model of the anaerobic metabolism of the biological phosphorus removal process: Stoichiometry and pH influence” from_Biotechnology Bioengineering as first published Mar. 15, 1994. The typical ASWT 21 system implementing EBPR 22 initially employs an anaerobic zone 33, where anaerobic metabolism 34 takes place, as diagrammed in FIG. 2. Next, as typically followed by one or more anoxic zone 35 and one or more aerobic zone 32, aerobic and anoxic metabolism 36 takes place, with note that the term “stage” is often used as an equivalent for the term “zone”, especially when the zones are present in sequence or proximate to one another.

Multiple stages of anoxic zones 35 and aerobic zones 33 are often included in the EBPR 22 process designs. An example of a prior art, multi-stage EBPR design is shown schematically in FIG. 3. In the conventional ASWT 21 process with the basic BNR 22, as shown in FIG. 1, the process typically includes an anaerobic zone 34, followed by one or more of the anoxic zones, and then by one or more aerobic zones 32. More than one of each of these anaerobic, anoxic, or aerobic zones may be employed. This basic process design is based upon the known “Modified Bardenpho Process,” with typically one or more anaerobic zones to promote EBPR and also to provide a strong selective pressure against filamentous bacteria growth, while at the same time promoting the growth of a denser, better settling biomass in the activated sludge 25.

As used herein, the term “anoxic” generally refers to the absence of oxygen, whereas the term “anaerobic” generally refers to life under anoxic conditions, literally ‘living without air’. Conventionally, in the activated sludge wastewater treatment system (ASWT) 21, the absence of oxygen alone is indicated “anoxic”, while the term “anaerobic” is used to indicate the further absence of any common electron acceptor, such as nitrate, sulfate or oxygen.

The wastewater influent 28 in an ASWT 21 is typically a municipal waste stream. A suspension of bacteria and other microorganisms referred to as a mixed liquor 38, is received into and maintained in an aeration basin 39 within the typical ASWT 21 system, for conversion of wastewater influent with mixed liquor into activated sludge 40 that then is transferred to a clarifier 41. As shown in FIG. 3, the effluent from the aeration basin flows to the clarifier, where the mixed liquor settles and is returned to the aeration basin, and where a clarified effluent 42 as a treated wastewater overflows the clarifier for optional additional treatment, disinfection, and then disposal. As shown in FIGS. 1 and 3, a fraction of the settled mixed liquor 40 is removed or “wasted” from the clarifier underflow as waste activated sludge (WAS) 43, and typically routed to a separate digestion process in order to maintain the desired concentration of mixed liquor in the aeration basin.

A large portion of the nitrate produced in the conventional ASWT process 21 with the conventional NdN 24 process is recycled to an anoxic zone 35, located upstream in the ASWT 21 system, where nitrate is used by denitrifying bacteria in the absence of oxygen to oxidize carbon provided in the wastewater influent 28. The low nitrate concentrations in the wastewater influent and a “return activated sludge” (RAS) 44, which is recycled from the clarifier 41, enables the first contact zone to be anaerobic, which provides an advantage for the selection of “polyphosphate accumulating organisms” (PAOs) 45.

In the anaerobic contact zone the PAOs 45 store “readily biodegradable carbon substrate” (rbCOD) in the influent wastewater in the form of “volatile fatty acids” (VFAs) as “polyhydroxyalkanoates” (PHA), by using the energy provided from glycogen resources and their release of stored phosphorus. In the aerobic zone and in the anoxic zone, PAOs oxidize the internally stored PHAs either with oxygen or with nitrate/nitrite, respectively. The energy provided by this oxidation results in phosphorus uptake and storage by PAOs, replenishment of their glycogen pool and production of more phosphorus-rich PAO biomass. Phosphorus (P) is thus ultimately removed from the liquid phase due to storage in the PAOs that routinely leave the system with the WAS 40.

There is a need for increasing the opportunity and availability for a more efficient recovery of P in the processing of municipal and industrial wastewater using ASWT 21, which also addresses the needs of smaller size facilities. Types of ASWT's in need of improved P recovery processes and methods include the ASWT 21 system, oxidation ditches, and other small activated sludge systems.

In the conventional biological nitrogen removal (BNR) 22 process employed in “wastewater treatment plants” (WWTPs), nitrogen removal is achieved through NdN 24, which includes nitrification as the oxidation of ammonium to nitrate, catalyzed by bacteria and is key to re-cycling nitrogen on a global scale. In the NdN process, nitrification is followed by denitrification, which is the biological reduction of nitrite and nitrate to nitrogen gas by heterotrophic bacteria consuming organic carbon under anoxic conditions.

$$2 {NH}_{4}^{+} + 3 {O}_{2} \to 2 {NO}_{2}^{-} + 4 {H}^{+} + 2 {H}_{2} O \qquad ( Eq . 1 )$$

$$2 {NO}_{2}^{-} + {O}_{2} \to 2 {NO}_{3}^{-} \qquad ( Eq . 2 )$$

In the first step of nitrification, chemolithoautotrophic ammonia-oxidizing bacteria (AOB) oxidize ammonium to nitrite, as per the above Eq. 1. Nitrite is subsequently oxidized to nitrate per the above Eq. 2, by “nitrite-oxidizing bacteria” (NOB).

Undesirably, when nitrate or oxygen is discharged to the anaerobic zone, they prevent fermentation of rbCOD to acetic acid and to propionic acid. Additionally, discharge of nitrate or oxygen to the anaerobic zone deprives the PAOs of the substance that they need to store for growth and phosphorus removal, in that nitrates or “dissolved oxygen” (DO) could serve as electron acceptors for PAOs and other organisms that will metabolize the VFA, typically present in the activated sludge 25.

Therefore, common BNR 22 designs typically utilize internal recycle streams such that minimal nitrate or DO is returned to the anaerobic zone 33. These pumped recycle stream flow rates must be carefully regulated to assure that the desired process objectives are achieved. These types of BNR 22 facilities are more complex than conventional WWTPs, in terms of operation and control and are more expensive to construct, operate, and maintain. Because of the added cost and complexity of multi-stage phosphorus and nitrogen removal systems, many WWTPs, particularly smaller WWTP's plants, typically considered as processing less than 5 MGD (million gallons per day), have up to now often elected to utilize chemical precipitation instead when needed to meet permit requirements for P removal.

Smaller WWTPs have more often relied heavily on chemical precipitation, where P removal is required to protect effluent receiving waters. This is a very important consideration because P as a “biological” or “soluble phosphorous” (SP) 37 can be recovered as a byproduct of EBPR 23 systems for beneficial use as fertilizer, while chemical precipitates of P typically are removed using metal salts and for all practical purposes are not recoverable. A key benefit of the present invention is to make possible a simple, low cost recovery system of the SP for smaller WWTPs, with the improved technology and methods disclosed herein as can be applied to many plants without requiring anaerobic digestion.

Modern sanitation practice and large scale food production methods have broken the cycle of P reuse in food production by way of the limited recycle of human waste as agricultural fertilizer. Instead, there is a high dependence on inorganic P fertilizer to meet the nutrition needs of the world's growing population. At the same time, phosphate rock from which P fertilizers are produced is a non-renewable resource, which is being rapidly depleted. The collection and treatment of domestic wastewaters is also an essential part of modern life, but the discharge of P and N in effluent from WWTPs contributes to the acceleration of eutrophication in surface waters and the deterioration of conditions for aquatic life. According to the USEPA, nearly every State has nutrient related pollution with negative impacts to over eighty significant estuaries and bays, and to thousands of rivers, streams, and lakes. More stringent discharge permit limits for effluent nutrients from WWTPs are becoming more frequent in efforts to minimize and prevent water quality impairment from eutrophication. A common effluent limit for P is a concentration of less than 0.10 mg/L, and for N a “total nitrogen” (TN) concentration of less than 3.0 mg/L, with P often the major nutrient of concern in freshwater impacted by WWTPs discharge or runoff.

Municipal and industrial wastewater treatment systems able to develop “aerobic granular sludge” (AGS) 31 represent an emerging technology, which offers significant advantages over conventional flocculent activated sludge treatment systems. AGS has better settling properties providing for more effective biomass-water separation and higher biomass concentrations in the reactor tanks. Each AGS granule is a self-contained treatment system which can achieve simultaneous nitrification, denitrification and phosphate removal. In this way, AGS systems reduce reactor sizes and space requirements, lower energy costs, and reduce capital costs.

Currently, most full-scale commercial installations that have consistently produced AGS 31 microbiology, utilize a “sequencing batch reactor” (SBR) reactor process. However, the great majority of conventional, flocculent activated sludge wastewater treatment plants are continuous flow systems equipped with separate aeration tanks and clarifier tanks. The clarifiers, or sedimentation tanks, serve to separate the microbial biomass from the treated liquid to be discharged and for return of the settling biomass back to the aeration basins as a “return activated sludge” (RAS) 44.

There is a need for increasing opportunities for realizing the benefits of AGS 31 by making it possible to consistently and reliably achieve conditions that support the development of AGS microbiology in continuous flow activated sludge wastewater treatment 21 process designs.

### BRIEF DESCRIPTION OF THE DRAWINGS

Exemplary embodiments of the technology will become more fully apparent from the following descriptions and appended claims, taken in conjunction with the accompanying drawings. Understanding that these drawings depict only exemplary embodiments and are, therefore, not to be considered limiting of the scope of the technology, the exemplary embodiments will be described with additional specificity and detail through use of the accompanying drawings in which:

FIG. 1 is a prior art simplified schematic diagram for a typical EBPR process design;

FIG. 2 is a prior art diagram of a conventional biological nutrient removal process;

FIG. 3 is a prior art schematic diagram of a typical multi-stage EBPR process design;

FIG. 4 is a detail drawing depicted the present invention in which the anaerobic and anoxic selector zones and individual stages can be operated in series or in parallel and the internal recycle flow can be directed to any of the stages to support start-up and development of AGS.

FIG. 5 is a schematic diagram of a preferred embodiment of the Phosphorus and Nitrogen Removal System of the present invention depicting a first step in an initial start-up sequence;

FIG. 6 is a schematic diagram of a preferred embodiment of the Phosphorus and Nitrogen Removal System of the present invention depicting a second step, which begins a transition sequence in which an internal recycle is redirected within the System;

FIG. 7 is a schematic diagram of a preferred embodiment of the Phosphorus and Nitrogen Removal System of the present invention depicting a third step, which continues the transition sequence in which an internal recycle is redirected within the System;

FIG. 8 is a schematic diagram of a preferred embodiment of the Phosphorus and Nitrogen Removal System of the present invention depicting a forth step, which continues the transition sequence in which an internal recycle is redirected within the System;

FIG. 9 is a schematic diagram of a preferred embodiment of the Phosphorus and Nitrogen Removal System of the present invention depicting a first alternative for implementing a fermentation cycle within the anaerobic and anoxic selector stages;

FIG. 10 is a schematic diagram of a preferred embodiment of the Phosphorus and Nitrogen Removal System of the present invention depicting a second alternative for implementing a fermentation cycle within the anaerobic and anoxic selector stages;

FIG. 11 is a schematic diagram of a preferred embodiment of the Phosphorus and Nitrogen Removal System of the present invention depicting a third alternative for implementing a fermentation cycle within the anaerobic and anoxic selector stages;

FIG. 12 is a schematic diagram of a preferred embodiment of the Phosphorus and Nitrogen Removal System of the present invention, utilizing an oxidation ditch reactor or closed loop reactor;

FIG. 13 is a schematic diagram of a preferred embodiment of the Phosphorus and Nitrogen Removal System of the present invention depicting an initial start-up step;

FIG. 14 is a schematic diagram of a preferred embodiment of the Phosphorus and Nitrogen Removal System of the present invention depicting a second step that begins a transition sequence in which an internal recycle is redirected within the System;

FIG. 15 is a schematic diagram of a preferred embodiment of the Phosphorus and Nitrogen Removal System of the present invention depicting a third step that continues the transition sequence in which the internal recycle is redirected within the System;

FIG. 16 is a schematic diagram of a preferred embodiment of the Phosphorus and Nitrogen Removal System of the present invention depicting a forth step that continues the transition sequence in which the internal recycle can be turned off; and

FIG. 17 is a schematic diagram of a preferred embodiment of the Phosphorus and Nitrogen Removal System of the present invention depicting the isolation of one anaerobic zone in the oxidation ditch reactor to implement a fermentation cycle within the System.

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and may include fragmentary views, graphic symbols, diagrammatic or schematic representations. Details that are not necessary for an understanding of the present invention by one skilled in the technology of the invention, or render other details difficult to perceive, may have been omitted.

### DETAILED DESCRIPTION OF SPECIFIC EMBODIMENTS

The present disclosure relates to and is applicable to the processing of municipal and industrial wastewater in an activated sludge treatment process. It is specifically applicable to a “activated sludge wastewater treatment system” (ASWTS) 21 that typically include compartmentalized activated sludge process treatment tanks or reactors, also referred to herein as a plurality of compartmentalized tanks 29 utilizing a “continuous flow activated sludge” (CFAS) 27 process. A primary objective of the present invention is to improve the performance and efficiency in the treatment of municipal and industrial wastewater in an activated sludge wastewater treatment system (ASWT) 21, removing phosphorus (P) and nitrogen (N). P and N removal is accomplished through “biological nutrient removal” (BNR) 11, by improved methods employing the “nitrification and denitrification” (NdN) 12, and by the “enhanced biological phosphorus removal” (EBPR) 23 processes.

The present invention includes a wastewater treatment system for removal of the biologically available P and N from the activated sludge 25, simply referred to herein as a “Phosphorus and Nitrogen Removal System” 30, or more simply as the “System” or the “System of the present invention”. Specifically, the Phosphorus and Nitrogen Removal System results in P as a phosphate ion rendered recoverable in soluble forms by employing an anaerobic fermentation of the activated sludge. This technical description of the Phosphorus and Nitrogen Removal System of the present invention is provided herein by way of example. However, it should be noted that other similar configurations and components could be utilized in applying the System.

Exemplary embodiments of the Phosphorus and Nitrogen Removal System 30 will be best understood by reference to the drawings included herewith, with like parts designated by like numerals throughout. It will be readily understood that the components of apparatus elements employed in the Phosphorus and Nitrogen Removal System of the present invention, as generally described and illustrated in the figures herein, could be arranged and designed in a wide variety of different configurations. Thus, the following detailed description of the embodiments of the System of the present invention with the preferred elements of its apparatus and method of its operation are not intended to limit the scope of the invention, as claimed, but is merely representative of exemplary embodiments of the technology.

The Phosphorus and Nitrogen Removal System 30 of the present invention can be applied to new and existing activated sludge process configurations to achieve improved performance in the basic activated sludge process, as well as conventional EBPR 23 systems, and include design elements that process the activated sludge 25. When densified and processed with the System of the present invention, the activated sludge has excellent settling properties and may be applied in alternative embodiments to other activated sludge process configurations with similar benefits.

Human activities can accelerate the rate nutrients such as P and N enter ecosystems. P is often the limiting nutrient in cases of “eutrophication”, which is generally defined as the undesirable process wherein a dense growth of plant life results in the death of animal life from lack of oxygen. Typically, eutrophication occurs in lakes and rivers subjected to excessive nutrient runoff and point source pollution from wastewater treatment plants.

Additionally, the phosphate mineral rock source of P fertilizer is a non-renewable and rapidly depleting natural resource. The System 30 of the present invention provides a more effective process control system to promote and maximize the use of EBPR 23, especially in situations where chemical precipitation for P removal otherwise might be used. This is important because P can be recovered as a by-product of EBPR systems for beneficial use as fertilizer, while P from chemical precipitates removed using metal salts cannot be effectively recovered. Furthermore, it is becoming increasingly common for regulatory agencies to impose limits on P, as well as N, in discharges from wastewater treatment plants. The biological removal of both of these nutrients is more complex since the efficiency of both processes is dependent, in part, on the available “organic carbon” (OC) substrate in the influent wastewater or from an external source, when necessary. OC is distinguishable from inorganic carbon in that OC is present in organic derived matter, whereas “inorganic carbon” C is largely found in carbonate minerals.

The Phosphorus and Nitrogen Removal System 30 of the present invention maximizes the efficiency of EBPR 23, while at the same time achieving the maximum biological N removal that can be obtained with the available OC in the influent wastewater. The System of the present invention can be implemented readily in both new and existing treatment facilities, and is applicable to both large and small wastewater treatment plants.

Additionally, the System 30 of the present invention changes the selective pressures on the microbial communities that make up the activated sludge used for biological nutrient removal, and thus the microbial population composition will change. These compositional changes will require microbial population consortia that are more effective at using the influent wastewater OC, to optimized P and N removal, and additionally include the development of an “aerobic granular sludge” (AGS) 31, as derived from the activated sludge 25 that first begins the process as the wastewater influent 28 in the AWST 21. An important and scientifically fundamental aspect of the present invention is to relate the changes in the reactor conditions and performance with changes in the microbial population responsible for ammonia and nitrite oxidation and for EBPR 23 and NdN 24.

Molecular detection methods allows a better understanding of the impact of each specific control action on the microbial community and on the specific organisms that are likely to predominant under a given set of operational conditions. A foremost goal of the Phosphorus and Nitrogen Removal System 30 of the present invention is to provide a better integration of knowledge and tools between the disciplines of engineering and the science of microbial biology to help realize more fully, the great potential of environmental biotechnology in EBPR 23 systems.

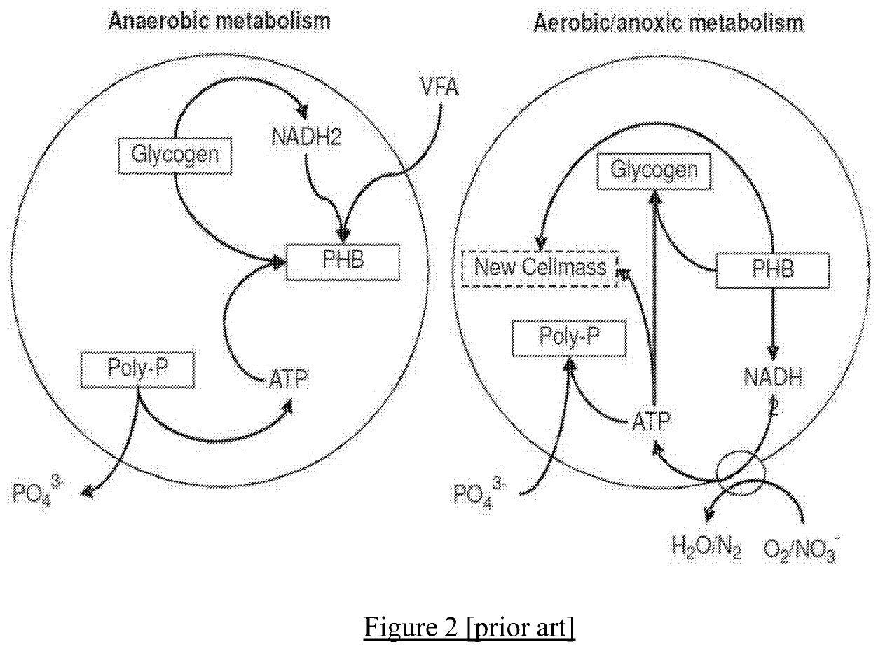

More specifically, OC in the wastewater to be treated is critical for driving biological denitrification and EBPR 23. Sufficient OC in the form of “readily biodegradable chemical oxygen demand” (rbCOD) is necessary for denitrifying bacteria to carry out denitrification. To achieve EBPR at a fundamental level, employing the metabolic process depicted in the prior art FIG. 2, it is necessary to provide the “polyphosphate accumulating organisms” (PAOs) 45 with adequate supply of rbCOD in form of “volatile fatty acids” (VFAs) 52 and appropriate anaerobic conditions free of nitrates. Thus, there is a competition for the available rbCOD between PAOs and denitrifying bacteria. When influent wastewater has a lower concentration of OC, the nutrient removal efficiency decreases, otherwise OC or C from an external carbon source as needs to be added.

In order to solve the problem of competition for the limited organic substrate, “denitrifying phosphorus accumulating organisms” (dnPAO) are the most desirable form of PAOs 45, over those that can only utilize or process oxygen. The dnPAOs are distinguished from “aerobic PAOs” (aPAOs) by their unique metabolic characteristic. The mechanism of anaerobic phosphate release of dnPAOs is the same as that of aPAOs. As further depicted in prior art FIG. 2, external organic substrate is taken up and converted to “polyhydroxyalkanoate” (PHA) as a cell energy storage product. Phosphorus is taken up under aerobic conditions by the aPAOs, which describes the basic concept, beyond as shown in FIG. 2, but uptake can also occur under anoxic conditions by dnPAOs.

The denitrifying ability of dnPAOs is a key factor in EBPR 23 process designs for simultaneous denitrification and P removal that can lead to savings in plant operational costs. dnPAO can combine phosphorus removal and denitrification into one process using the same amount of organic carbon substrate. In addition, less aeration is needed which translates into lower energy requirement. Thus, the advantage of selecting for dnPAOs over aPAOs by means of reactor configuration and by control strategies is very significant. Therefore, selection and enrichment of dnPAO is a key factor in optimizing EBPR and biological nitrogen removal and a primary objective of the Phosphorus and Nitrogen Removal System 30 of the present invention.

Until recently, it was accepted that phosphorus could only be removed in conventional EBPR 23 plants when the wastewater characteristics were favorable with an rbCOD/TP ratio of greater than 15:1. However, there are examples of non-conventional EBPR plants which perform very well in which the influent wastewater is discharged directly to the anoxic zone. In some cases, the only source of VFA was from the primary sludge fermenter or the “fermentation reactor vessel” (FRV) 40, producing VFA that was formed in the anaerobic zone by fermenting the RAS 44.

It has been suggested that the only possible source of the VFAs 52 when fermenting mixed liquor, especially RAS 44, was from the fermentation of non-PAOs, and that PAOs 45 survived better by having a much lower decay rate under anaerobic conditions. Under more prolonged and deeper anaerobic conditions, growth of other PAOs may be favored and their behavior may differ from that of the much researched the Accumulibacter species, as found mostly in conventional BNR 22 plants. Fermentation of RAS or mixed liquor under deeper anaerobic conditions such as indicated by an “oxidation-reduction potential” (ORP) process variable measurement 75 as low as −300 mV, allows for the growth of fermenting PAOs such as Tetrasphaera, which could produce additional VFA that would allow other PAOs such as Candidatus Accumulibacter to grow alongside them.

Tetrasphaera encompass a broad class of bacteria whose diversity has not been well characterized in the field of BNR 22. There are unique traits that some Tetrasphaera seem to share. All Tetrasphaera can ferment complex organic molecules such as carbohydrates and amino acids including glucose, glutamate and aspartate, and produce stored carbon in the process. Additionally, some Tetrasphaera species can produce VFA 52 (among other metabolites) during fermentation under reduced anaerobic conditions, which could be utilized as substrate by other PAOs 45. Further, most types of Tetrasphaera are able to denitrify and to couple nitrite/nitrate reduction with phosphorus uptake. Because of these behaviors, the net impact of Tetrasphaera on EBPR 23 can be significant, because, significantly more of the available carbon could be used for phosphate removal and PAO OC storage, rather than for growth of “other heterotrophic organisms” (OHO).

From experience with ASWT 21 processing during the development of the Phosphorus and Nitrogen Removal System 30 of the present invention, a most important parameter for optimal EBPR 23 is that a diversity of PAOs 45 must pass through a deep anaerobic zone defined by an “oxidation-reduction potential” (ORP) below a certain, predetermined value. Operational and experimental evidence points to an inability of most conventional EBPR plants to reduce the ORP to below this value. Tentative measurements suggest that ORP values that are at or below about-300 mV are linked to the growth of organisms like Tetrasphaera that thrive under those conditions. Tetrasphaera can ferment higher carbon forms, take up phosphorus, and produce VFA 52, which can be used by other PAOs while also taking up phosphorus under anoxic conditions.

The ability of Tetrasphaera to ferment higher carbon forms is particularly important for removal of phosphorus from the wastewater influents 28, which often do not contain sufficient rbCOD and from communities in colder regions that will not contain higher concentrations of VFA by the time is received into the WWTPs.

The Phosphorus and Nitrogen Removal System 30 of the present invention can be incorporated into existing or new ASWT 21 processes, to improve recovery of the P as a “soluble phosphorus” (SP) 37, also refer to herein as “biological phosphate”, from the activated sludge 25. Nitrification and denitrification (NdN) 24 are also improved with nitrogen removal achieved through NdN processes. The System of the present invention significantly improves operational energy efficiency of the ASWT 21 process.

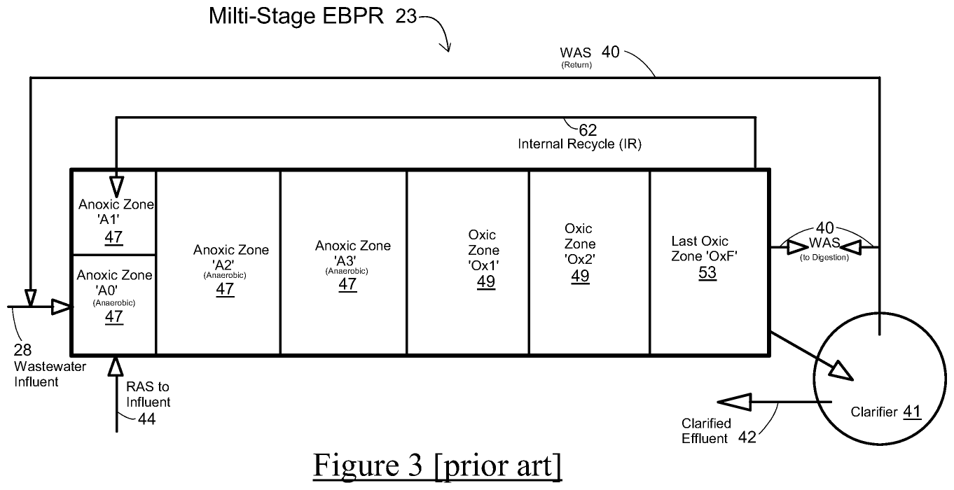

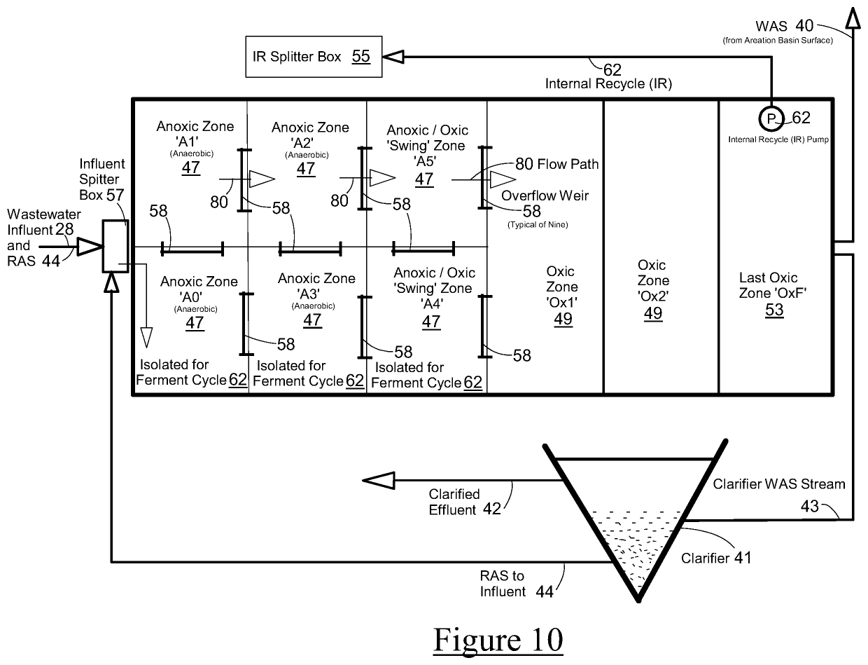

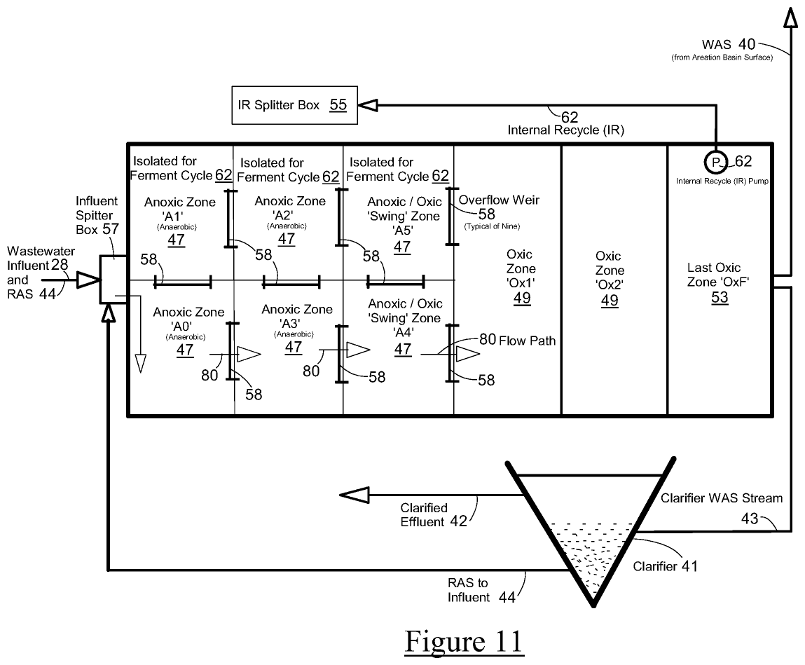

FIGS. 3 through 17, show features and steps of the Phosphorus and Nitrogen Removal System 30 of the present invention, as can be applied to new and existing treatment process designs most preferably utilizing the “continuous flow activated sludge” (CFAS) 27 process, and again with note that other similar process configurations could be utilized in applying embodiments of the novel method steps disclosed and described herein.

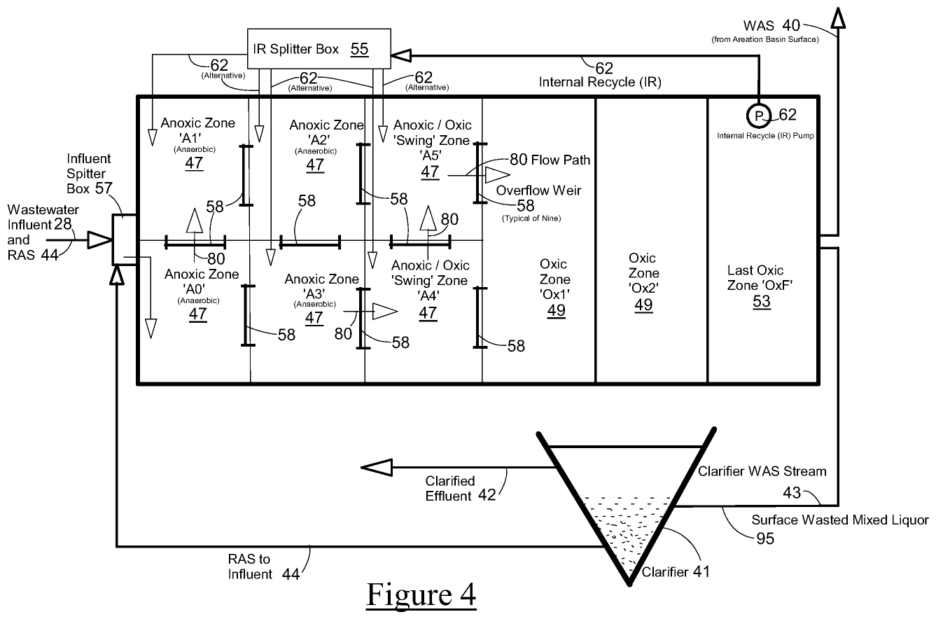

FIG. 4 schematically shows the Phosphorus and Nitrogen Removal System 30 for use in the ASWT 21 process. The System of the invention includes a plurality of compartmentalized tanks 29, which may be referred to in the alternative as “treatment trains”. Initially treatment trains include a “multiple of anoxic to anaerobic selectable stages” 46, which individually may be referred to herein as an “An/Ax” 47.

The multiple of anoxic to anaerobic selectable stages 46 are followed by a “multiple of aerated stages” 48, which individually may be referred to herein as an “Ox” 49, with the oxic operation of the Ox stage alternatively referable as the “aerobic” operation of the Ox stage. Any one of the multiple of anoxic to anaerobic selectable stages is a selectable stage, and is convertible and operable as either an anoxic stage or an anaerobic stage 47, again with the shorthand reference used herein of An/Ax.

An “internal recycle pump” (IR Pump) 50 is employed to pump an “internal recycle” (IR) 51 within Phosphorus and Nitrogen Removal System 30, as shown in FIGS. 4 through 17. The IR 51 is WAS 40 drawn from a last Ox 49 in the CFAS 27 process. Alternatively, the last Ox can be referred to herein as a “final aerated stage” OxF 53 of the multiple of aerated stages 48, in the CFAS.

As depicted in FIGS. 4 through 11, the IR 51 is pumped by the IR Pump 50 to an “internal recycle (IR) splitter box” 55. The IR splitter box selectively conveys and discharges the IR to any of the multiple of anoxic to anaerobic selectable stages 46. Alternatively, the IR splitter box can selectively convey and discharge the IR to a single An/Ax 47, or any combination of An/Ax stages of the multiple of anoxic to anaerobic selectable stages. As would be obvious to a person skilled in waste water treatment technology, the conveyance and distribution of internal recycle mixed liquor from the last aerated zone to one or more of the anoxic selector stages as described herein using a splitter box could similarly be accomplished utilizing a piping manifold with valves or gates or other equivalent hydraulic conveyance appurtenances.

In a preferred embodiment of the Phosphorus and Nitrogen Removal System 30, an overflow weir 58 is positioned between each of the multiple of anoxic to anaerobic selectable stages 46, with the multiple of anoxic to anaerobic selectable stages operable in a series stage operation or in a parallel stage operation, and most preferably with the operation of the multiple of anoxic to anaerobic selectable stages implemented automatically. The automatic operation of the multiple of anoxic to anaerobic selectable stages is preferably based upon an elapsed time, or alternatively based upon on a critical sensed process variable.

Most preferably, the overflow weir 58 is automated, with a downward opening weir gate. Such downward opening weir gates are well known in ASWT 21 processing, with the automated and coordinated operation of the overflow weirs is a unique operational element of the System 30 of the present invention. Preferably, as shown in FIGS. 4 through 11, one overflow weir is positioned between each of the multiple of anoxic to anaerobic selectable stages 46, with each overflow weir closable between the selector stages to isolate one or more of the selector stages for a quiescent settling 61 of the activated sludge 25 in a ferment cycle 62. This quiescent settling forms a densified settled bed 63 and additionally remains in the quiescent settling long enough for a densified settled bed fermentation 64 to occur. As would be obvious to a person skilled in waste water treatment technology, the transfer of the activated sludge 25, or the mixed liquor 38, from one zone or stage to a downstream zone or stage could similarly be accomplished utilizing a fixed or adjustable overflow weir and an adjustable submerged gate or valve located in a partition wall separating the zones.

The overflow weir 58 operates for a surface withdrawal of waste activated sludge (WAS) 40 from the last aerated stage 53, with a constant depth of the surface withdrawal of WAS maintained over the weir. Most preferably, the constant depth is maintained at a shallow enough level such that the WAS is withdrawn as laminar flow of liquid across the water surface of tank contents rather than upwelling from deeper levels of the tank.

In a preferred method of operation and control using the Phosphorus and Nitrogen Removal System 30, a stepwise transition from a conventional flocculent based ASWT 21 EBPR 23 system, into a densified activated sludge 25 EBPR system of the present invention. In the Phosphorus and Nitrogen Removal System of the present invention, the “aerobic granular sludge” AGS 31 predominates, which is capable of achieving simultaneous “nitrification and denitrification” (NdN) 24, to eliminate the prior need for “internal recycle” (IR) 51 conventionally routed from a aerated or aerobic zone 32 to an anoxic zone 35, with note that the term “stage” is often used as an equivalent for the term “zone”, and especially in ASWTs where the zones are present in sequence or proximate to one another.

In Phosphorus and Nitrogen Removal System 30 of the present invention, each anoxic zone 35 in series sequence is converted to an anaerobic zone 33 with the use of the re-routable internal recycle (IR) 51, with an IR discharge 66 into each of the multiple of anoxic to anaerobic selectable stages 46. By processionally changing location of the IR discharge 68 into the next anoxic stage in sequence, together with a commensurate decrease in the Internal Recycle flow rate.

For the System 30 of the present invention, vital process variables are input and monitored, most preferably to a microprocessor-based controller 70, enabling the accurate and precise execution and control of the process. The process variables input to the microprocessor-based controller, for use in a process control algorithm 71, as programmed into the microprocessor-based controller. The process control algorithm is most preferably a standard type of control algorithm written in a conventional programming code, to direct the logical output instructions of the microprocessor-based controller in the defined execution steps as disclosed herein. As a less preferred, alternative the process control algorithm can be executed from a personal or facility computer, or from a remote or a ‘cloud based’ processor or server.

A preferred embodiment of the Phosphorus and Nitrogen Removal System 30 of the present invention includes the creation of conditions that promote the ferment cycle 62 within the activated sludge 25 in the densified settled bed 63 in one or more of plurality of compartmentalized tanks 29 in the CFAS 27 process during one or more periods in each day. Additionally, the System includes a monitoring and control of the occurrence and duration of the fermentation conditions using ORP process variable measurements 76, and control of the aeration and mixing conditions within the activated sludge compartments to select for the growth of NdN 24 and PAOs 45, and to promote activated sludge having excellent settling properties. Also additionally, the system includes surface wasting excess bacteria as WAS, which further selects for activated sludge with excellent settling properties, while providing flexibility in the operation and control of the IR 51, for the aerated compartments to the anoxic compartments such that the internal recycle stream can be minimized or eliminated over time. The present invention will allow engineers and plant operators to better exploit the microbial communities which carry out EBPR 23 and NdN 24, to protect the environment and to significantly reduce the amount of energy and chemicals consumed in removing nutrients from wastewater discharges as compared to conventional ASWT processes 21.

An objective of the System 30 of the present invention, includes a creation of conditions that promote the densified settled bed fermentation 64 within the densified settled bed 63 of activated sludge 25, in one or more of the plurality of compartmentalized tanks 29, during one or more periods in each daily cycle of the CFAS 27 process. A further objective is a monitoring and controlling the occurrence and duration of fermentation conditions in the densified settled bed fermentation 64, which most preferably uses an ORP process variable measurement 75. Additionally, a control of the aeration and mixing conditions within the activated sludge compartments to select for the growth of NdN 24 and PAOs 45, along with the production of activated sludge with excellent settling properties 76.

The Phosphorus and Nitrogen Removal System 30 of the present invention allows engineers and plant operators to better exploit the microbial communities, which carry out enhanced biological phosphorus removal (EBPR) and nitrification/denitrification (NdN) to protect the environment and to significantly reduce the amount of energy and chemicals consumed in removing nutrients from wastewater discharges.

The innovative process configuration and system control methods of the System 30 of the present invention can be applied to EBPR 23 ASWT process 21 designs that utilize the continuous flow activated sludge process. The technical description of the innovation will be provided here by way of example, however, it should be noted that other similar process configurations could be utilized in applying this method.

Another key objective the System 30 of the present invention is to provide selective conditions which favor the formation of the Aerobic Granular Sludge (AGS) 31 in a “continuous flow activated sludge” (CFAS) process 27, and to provide the operational flexibility to transition from a conventional flocculent activated sludge EBPR system at start up to a predominantly AGS system once the system has reached steady state conditions. The design configuration and the associated operational flexibility of the present invention are depicted in FIG. 4. The multiple anaerobic/anoxic selector zones can be configured to operate either under anaerobic or anoxic conditions. The last two selector zones can be operated under anaerobic, anoxic, or aerobic conditions. The objective at steady state is to operate with multiple anaerobic stages in series followed by aerobic stages where simultaneous nitrification and denitrification occurs within aerobic granular sludge microbial communities.

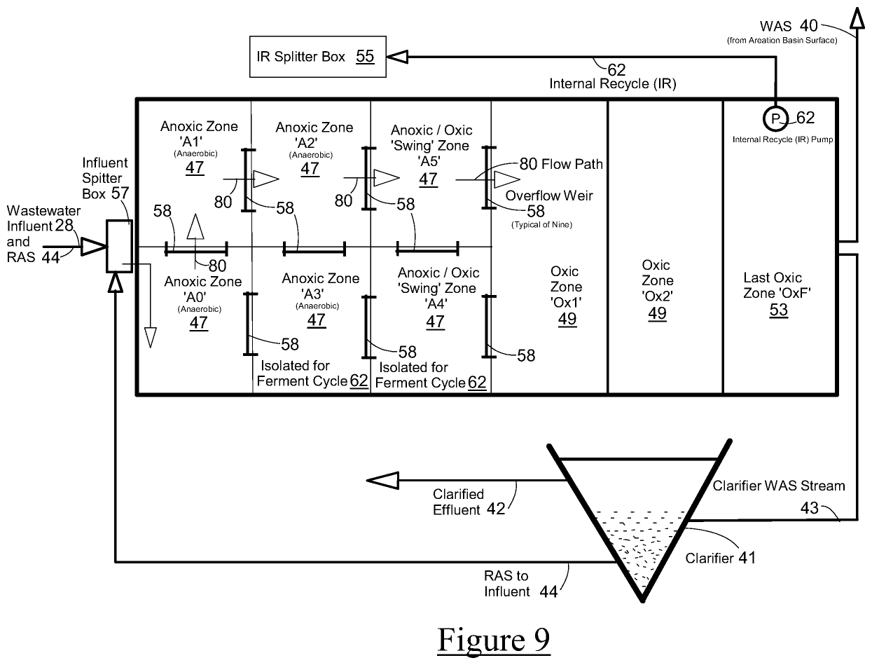

The multiple of anoxic to anaerobic selectable stages 46 can be operated in either series or in parallel by utilizing automated downward opening weirs. In this way one or more of the selector stages can be isolated and allowed to settle so that fermentation conditions are achieved in the settled bed. FIGS. 9, 10, and 11 depict alternative configurations for implementing the ferment cycles in the multiple of selectable stages. By isolating the settled bed fermentation cycles in this manner, the problem of short circuiting across the surface of the selector tank can be avoided. The problem of short circuiting limits the applicability of inline fermentation which has been utilized in conventional plug flow compartmentalized activated sludge systems.

A deeply anaerobic fermentation period, where ORP values are −300 mV or less, is achieved in the ferment cycle 62 one or more times during in each 24-hour period helps to re-cover carbon which can be taken up by PAOs 45 to improve P and N removal. The ferment cycles also provide selective pressure which favors the development of AGS 31. WAS 40 is removed by surface wasting from the OxF 53, which also provides a selective pressure that also favors the development of AGS.

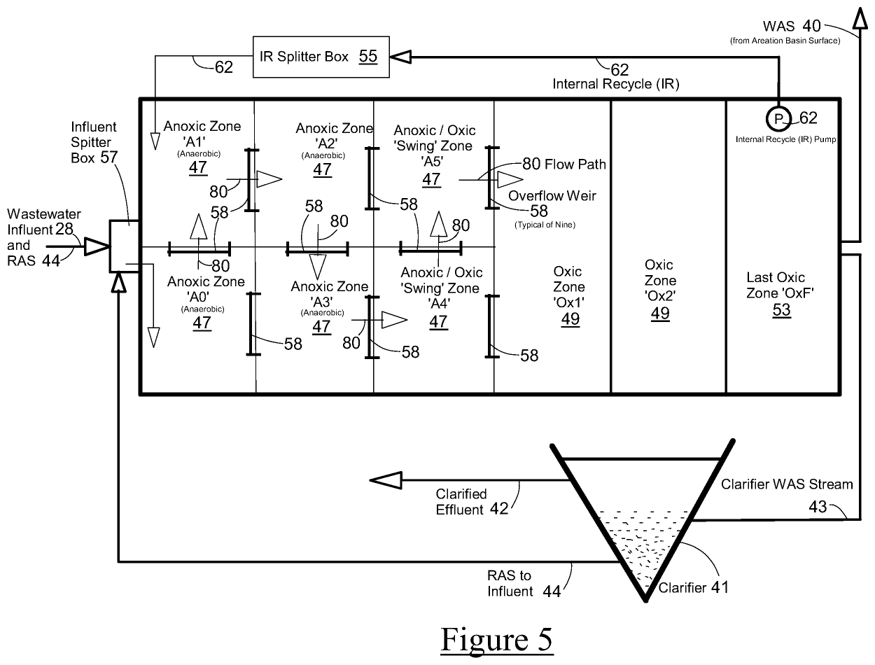

The presence of PAOs 45 is the starting point for the development of AGS 31. Therefore, the present invention is designed so that it can initially be operated as a conventional flocculent EBPR 23 system. The IR splitter box 55 is provided to provide complete flexibility as to which stage or stages receive the IR 51 from the OxF 53 or “final aerated stage” of the multiple of aerated stages 48. FIGS. 5, 6, 7, and 8 depict a typical progression of the start up and transition steps the Phosphorus and Nitrogen Removal System 30 of the present invention, in which the IR flows are sequentially reduced and moved further downstream in the sequence of the selector stages.

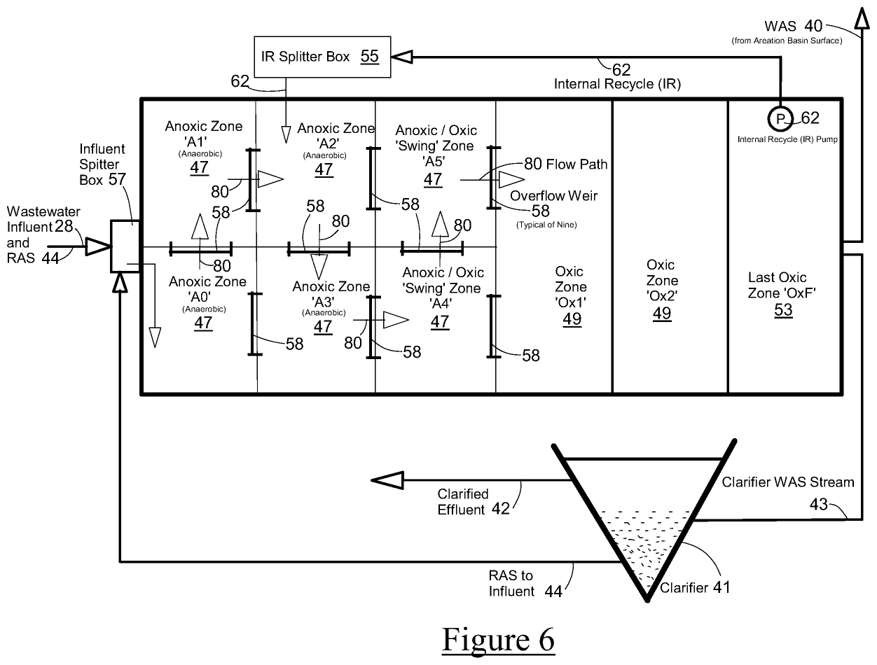

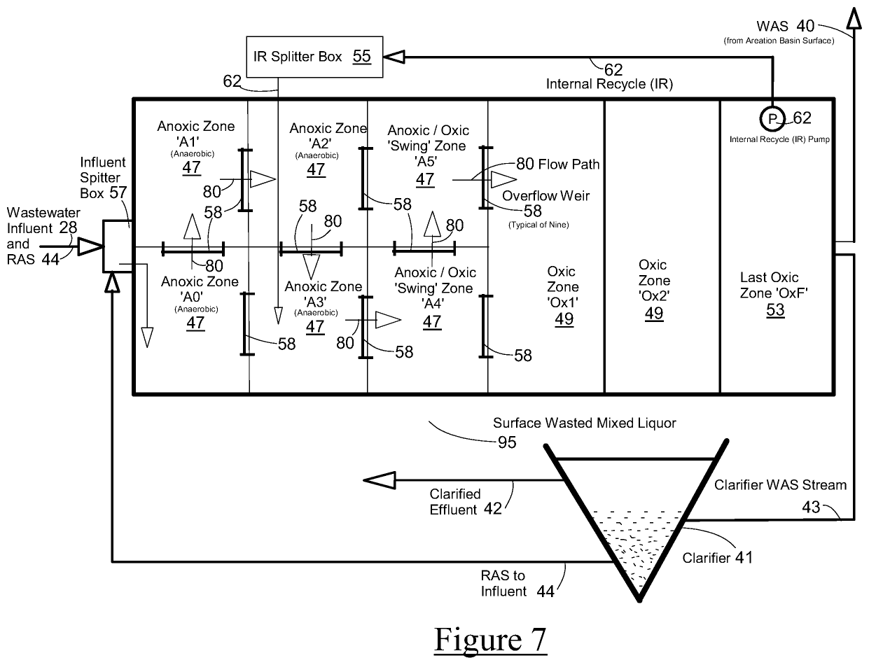

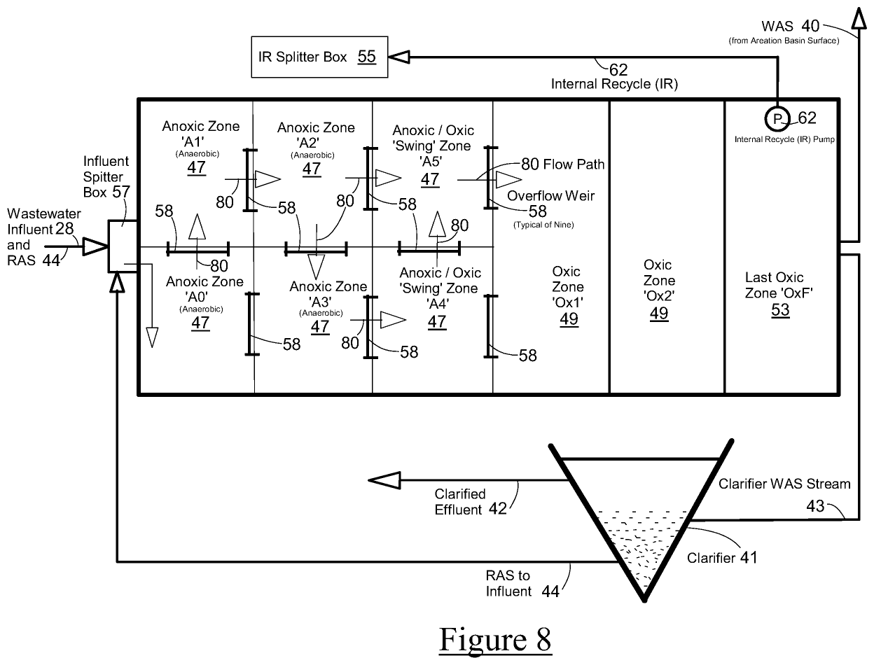

FIG. 5 depicts a first step in an initial start-up sequence, in which the internal recycle from Ox3 is directed to one of the first anoxic stages as necessary to develop PAOs in the system. FIG. 6 depicts a second step, in which a transition sequence begins with the internal recycle from Ox3 directed to one of the next anoxic stages, as necessary to develop PAOs while creating conditions that initiates development of some AGS 31, which in turn allows for a flow rate reduction of the internal recycle. FIG. 7 depicts a third step, in which the transition sequence continues with the internal recycle from Ox3 is directed to one of the next anoxic stages, as necessary to develop PAOs in the system while creating conditions that enhance continuing development of additional AGS, and allows a further reduction in the internal recycle flow rate. And FIG. 8 depicts a forth step, which continues the transition sequence with the internal recycle from the Ox3 is directed to one of the next anoxic stages, as further necessary to develop PAOs in the system while creating conditions that enhance the continuing development of AGS, and in turn allows for still a further reduction in the internal recycle flow rate.

When the AGS 31 development is sufficient to provide for simultaneous NdN 24 in the Ox 49, the internal recycle can be turned off completely. Implementation of intermittent ferment cycles 62 can begin before the transition to an AGS system is complete at start up as shown in FIG. 5, if desired.

A preferred embodiment of the Phosphorus and Nitrogen Removal System 30 of the present invention preferably includes incorporation of at least four of the anaerobic/anoxic selector stages (An/Ax) 47, and most preferably six or more An/Ax to comprise the multiple of anaerobic/anoxic selector stages 46, as located proximate to at the influent end 81 of the CFAS 27 reactor that receives the wastewater influent 28, and the CFAS reactor including the plurality of compartmentalized tanks 29 or treatment trains as depicted in FIG. 4.

The CFAS 27 reactor in the System 30 of the present invention also includes the overflow weir 58 that is automated, with a downward opening weir gate to control a flow 80 of the activated sludge 25 a shown in FIGS. 5 through 10 and 13 through 17, as passing through the CFAS process, and from one selector stage to the adjacent selector stage of the multiple of An/Ax selector stages 46, which allows for operation of the selector stages in series or in parallel, and allows for isolation of one or more of the multiple of An/Ax selector stages for quiescent settling 61 of the activated sludge 25 and densified settled bed fermentation 64 under quiescent conditions, as depicted in FIGS. 9, 10, and 11.

Additionally, the CFAS 27 reactor in the System 30 of the present invention includes a multiple of mixers 82 for continuously or intermittently mixing each of the multiple of An/Ax selector stages 46. Also, a multiple of aerators 83 are included for continuously or intermittently aerating at least the multiple of aerated states 48.

Also, the CFAS 27 reactor in the Phosphorus and Nitrogen Removal System 30 of the present invention allows for operation of the overflow weir 58 that is automated, with a downward opening weir gate for the surface withdrawal 65 of the WAS 40 from the OxF 53 of the multiple of aerated stages 48, while the tank contents are being mixed using one of the multiple of aerators 83 that can include a diffused aeration system, or injection of compressed air, or one of the a multiple of mixers 82.

Also additionally, the CFAS 27 reactor in the System 30 of the present invention includes the IR Pump 50, for pumping the IR 51 of WAS 40 from the final aerated stage (OxF) 53 of the multiple of aerated stages 48 to the IR splitter box 55, as preferably located in proximity to the multiple of An/Ax selectable stages 46 toward the influent end 81 of the CFAS 27 process with the plurality of compartmentalized tanks 29. Furthermore, the Internal Recycle mixed liquor flow, is directed from the IR splitter box to any one or more of the multiple of An/Ax selectable stages 46 by use of control gates located on the outlet pipes from the IR splitter box to any of the multiple of An/Ax selectable stages. Additionally, the ORP process variable measurement 75 is acquired in the settled mixed liquor bed in each of the multiple of An/Ax selectable stages during the ferment cycle 62, as depicted in FIGS. 9, 10, and 11. Measurement of VFA's 52, and other readily “biodegradable biochemical oxygen demand” (BOD) in the activated sludge 25 within each densified settled bed 63 for each of the multiple of An/Ax selector stages 46 during the ferment cycle 62, is also performed, as preferred and as depicted in FIGS. 9, 10, and 11, most preferably using a bioelectrode sensor as are conventionally known to those skilled in the field of BOD measurement.

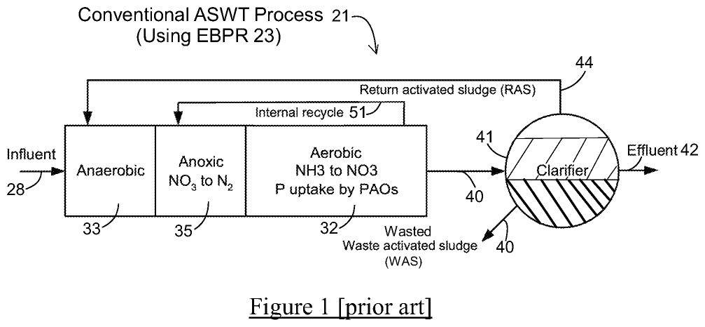

Also most preferably, dynamic process control methods and strategies are incorporated into the System 30 of the present invention, for each of the plurality of compartmentalized tanks 29 in the CFAS 27 process. For the initial operation to achieve EBPR 23, since the presence of PAOs 45 is essential to the development of AGS 31, the present invention is first operated as a conventional flocculent activated sludge EBPR 23 system. Again, FIG. 1 depicts a simple schematic of a conventional EBPR system utilizing anaerobic, anoxic, and aerated zones with internal recycle from the aerated zone to the anoxic zone in order to minimize the amount of nitrate returned to the anaerobic zone in the RAS 44. Initial operation of the Phosphorus and Nitrogen Removal System can begin with one of the multiple of An/Ax selector stages 46, where the internal recycle flow is directed from the IR splitter box 55 to the first An/Ax 47 stage as depicted in FIG. 5. Alternatively, the initial operation could begin with two anaerobic stages as depicted in FIG. 6. Also, an intermittent ferment cycle in isolated selector stages can begin during this initial operational phase, as depicted in FIGS. 9, 10, and 11.

The ferment cycle 62 supports the development of PAOs 45, and provide for a greater diversity of PAOs including the aforementioned desirable Tetrasphaera PAOs, which are able to induce the fermentation more complex substrates to produce VFAs 52. It has also been observed that the fermentation cycle 62 can help to promote the development of AGS 31. The IR 51 is needed during the initial operation phase of the Phosphorus and Nitrogen Removal System 30, to provide for denitrification of the nitrate and nitrite produced in the multiple of aerated stages 48, so that nitrate and nitrite in the RAS 44, which is returned to the An/Ax 47 or anaerobic stages and is kept to a minimum. In a conventional flocculent activated sludge EBPR 23 system, internal recycle is discharged to the first anoxic zone. In order to provide for a transition from flocculent inoculated activated sludge 25, the system of the present invention pumps the flow of the IR 51, the IR splitter box 55 is equipped with control gates ahead of separate outlet pipes, as routed to each of the anoxic stages shown in FIG. 4.

Based on the measured nitrate and nitrite concentrations in the IR 51, the flow rate of the IR can be reduced and the IR discharge 66 location can be changed to the next downstream anoxic stage. This operational progression in this transition from EBPR 23 to AGS 31 is depicted in FIGS. 6, 7, and 8. When sufficient AGS has been developed in the CFAS 27 process with the Phosphorus and Nitrogen Removal System 30 of the present invention, simultaneous NdN 24 will occur in the multiple of aerated states 48, with the nitrate and nitrite concentrations in the last Ox 53 will be low enough that the IR pump 50 can be shut off. At this point, all of the selector stages will be operating under anaerobic conditions. The last one or two An/Ax 47 selector stages can be aerated continuously or intermittently, once the system has developed sufficient AGS.

Through the use of the automated downward opening overflow weirs 58 between the An/Ax 47 selectable stages, the multiple of An/Ax selectable stages 46 can be operated in series or operated in parallel. Individual stages can be isolated and allowed to settle under completely quiescent conditions to maximize the benefits of fermentation within a densified settled bed 63 of activated sludge 25. In-line fermentation could have been accomplished in prior BNR 22 systems that do not incorporate the features of the present invention, but the timing and duration of in-line fermentation, where the stage cannot be isolated is much more restricted and will not be as effective. Without isolation, short circuiting will occur across the top of the plurality of compartmentalized tanks 29, which can lead to filamentous bacteria growth in the aerated stages, reduced nutrient removal, and other potential problems. Continued flow 80 through a stage when mixing is shut off will also adversely affect settling of the activated sludge 25, which can in turn reduce the effectiveness of the ferment cycle 62.

Three different options for isolating individual stages for the ferment cycle 62 are shown in FIGS. 9, 10, and 11, respectively. Additional alternative options for isolating one or more stages are possible, though not shown in these figures. Sensors for ORP process variable measurement 75 and possibly bio-electrode sensors can be installed for monitoring fermentation conditions in the settled bed during the ferment cycles.

FIG. 9 depicts a first alternative for implementing a fermentation cycle within the multiple of anaerobic to anoxic selectable stages 46. Each fermentation cycle can begin concurrently with the start up and transition sequences and can continue indefinitely thereafter. Additionally, each fermentation cycle helps promote a more diverse population of PAOs including desirable Tetrasphaera, which help to make additional carbon available to PAOs and to thereby limit the growth of other heterotrophic organisms which would otherwise utilize some of the available carbon, and the fermentation conditions also provide a selective advantage to the formation of AGS.

With the automated downward opening overflow weir 58, as installed in the OxF 53 to remove the WAS 40 from the Ox 49, the Phosphorus and Nitrogen Removal System 30 of the present invention. The automated overflow weir is controlled to maintain a relatively constant depth over the weir in the approximate range of 1 cm to 2 cm. Such a wasting strategy provides a selective pressure which favors retention of the denser, better settling AGS 31 in the system. It works with the other selective pressures utilized in the present invention as described above to effectively transition from a conventional EBPR 23 system to a system in which the AGS predominates.

Once the AGS 31 has become the predominant form of activated sludge 25 being processed within in the CFAS 27 process employing the Phosphorus and Nitrogen Removal System 30 of the present invention, the IR Pump 50 can remain off-line. Ongoing operational adjustments may include control of the duration and frequency of ferment cycles 62. In the event that an increase in nitrate and/or nitrite levels in the OxF 53 stage are observed, the IR pump 50 can be turned on at a low rate with the internal recycle flow directed to the last anoxic stage until the nitrate and nitrite levels have been sufficiently reduced to avoid concerns about discharging excessive nitrate and nitrite to the multiple of anoxic to anaerobic selectable stages 46.

The above description of the present invention is applied to a CFAS 27 process for processing activated sludge 25 that is divided using partition walls into zones and stages to create anaerobic, anoxic, and aerobic conditions to achieve the necessary process flow sequences to accomplish the transition to aerobic granular sludge within the activated sludge process. For long narrow reactors with a sufficient length to width ratio, including but not limited to oxidation ditches, “virtual” zones and stages can be created by installing a mixing system in each zone or stage which creates a vertical mixing regime. Such a mixing regime can be created using compressed gas large bubble mixing, some types of top mounting mechanical mixers, and properly oriented pumped mixing systems.

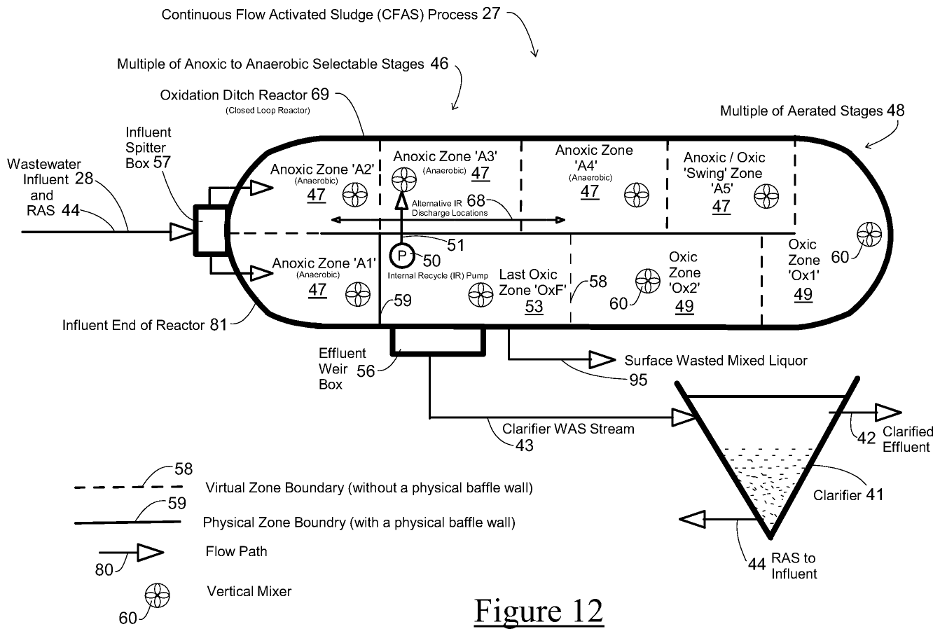

FIG. 12 is a schematic diagram of the CFAS 27 process that is an oxidation ditch reactor 69 or closed loop reactor, as applied to the Phosphorus and Nitrogen Removal System 30 of the present invention, where the oxidation ditch reactor serves as a long narrow reactor in which virtual zones and stages can be create without the installation of a physical baffle wall, which can be described herein as a virtual zone boundary 58, as opposed to a physical zone boundary 59 that requires installation of a physical baffle. The virtual zone boundary requires that a vertical mixing system 60 is utilized. The multiple virtual anaerobic and virtual anoxic selector stages, and the multiple of aerated stages are most preferably partitioned with a virtual zone boundary, created through the use of mixing systems which mix vertically in each zone or stage, rather than horizontally. The virtual zone boundary is an equivalent of a compartmentalized stage, and does not use the physically partitioning baffle between the multiple of anaerobic to anoxic selectable stages and the multiple of aerated stages in the elongated closed loop reactor.

For a preferred embodiment of the System 30, all anaerobic and anoxic zones are provided with vertical mixing systems 60, such as compressed gas mixing low pressure air large bubble mixing or other mixing systems, which do not produce horizontal flow conditions. Oxic zones (Ox) may also be provided with vertical mixing systems, in addition to conventional fine-bubble diffused aeration systems.

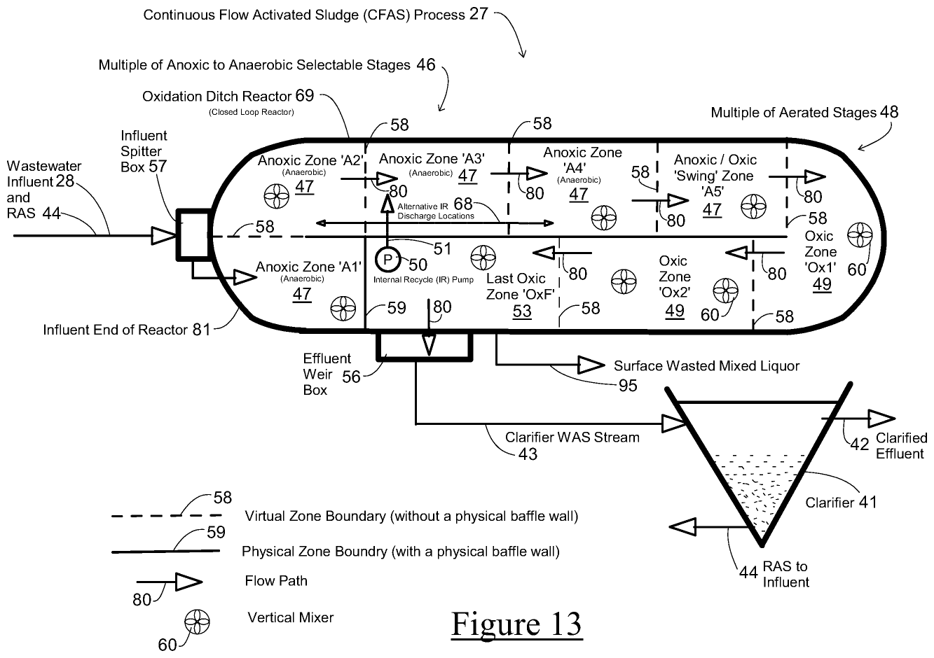

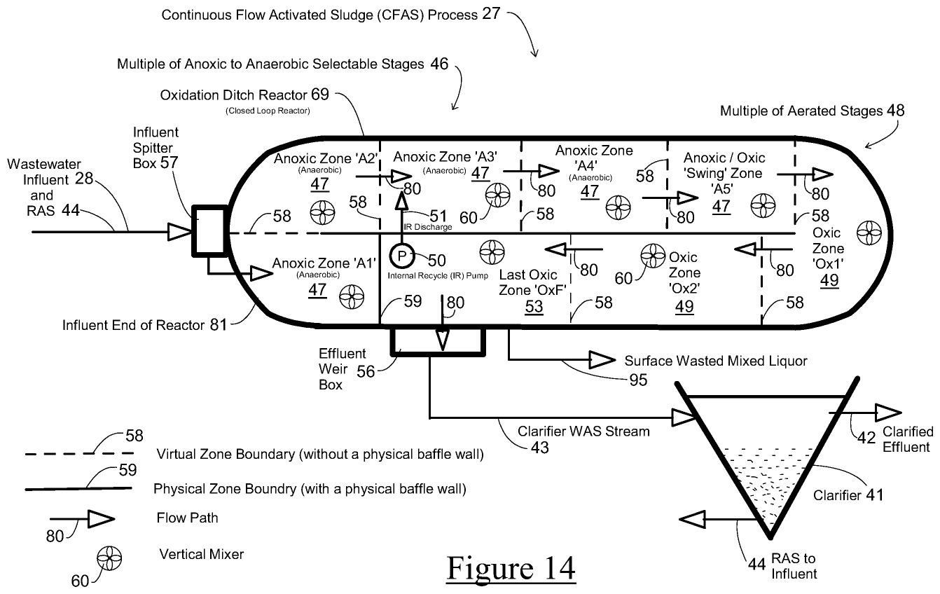

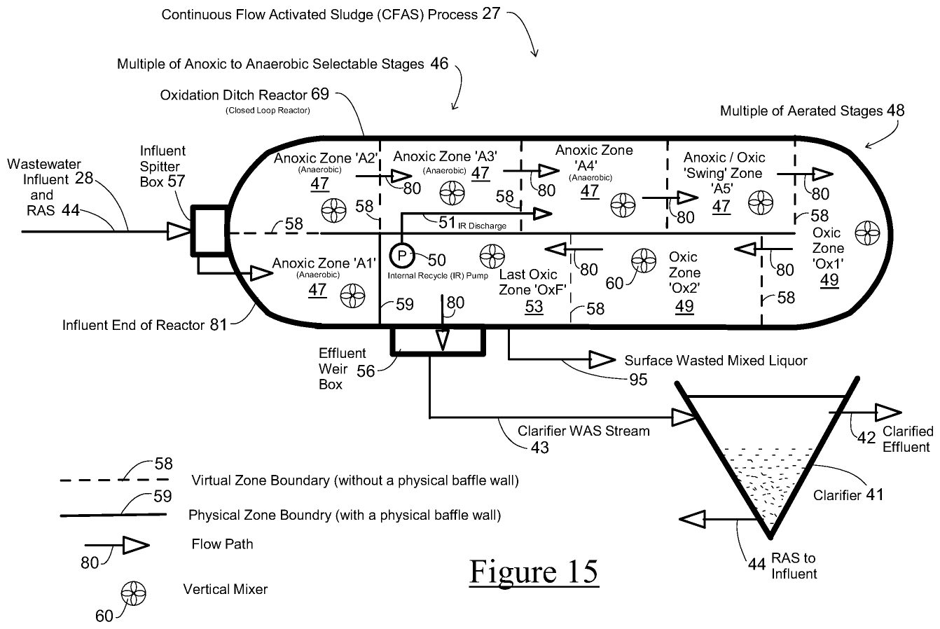

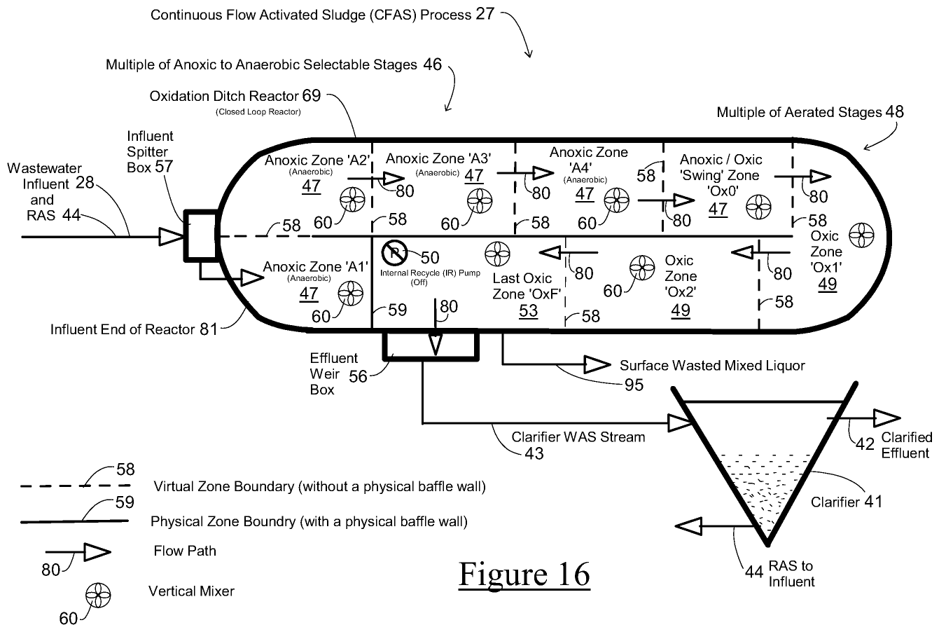

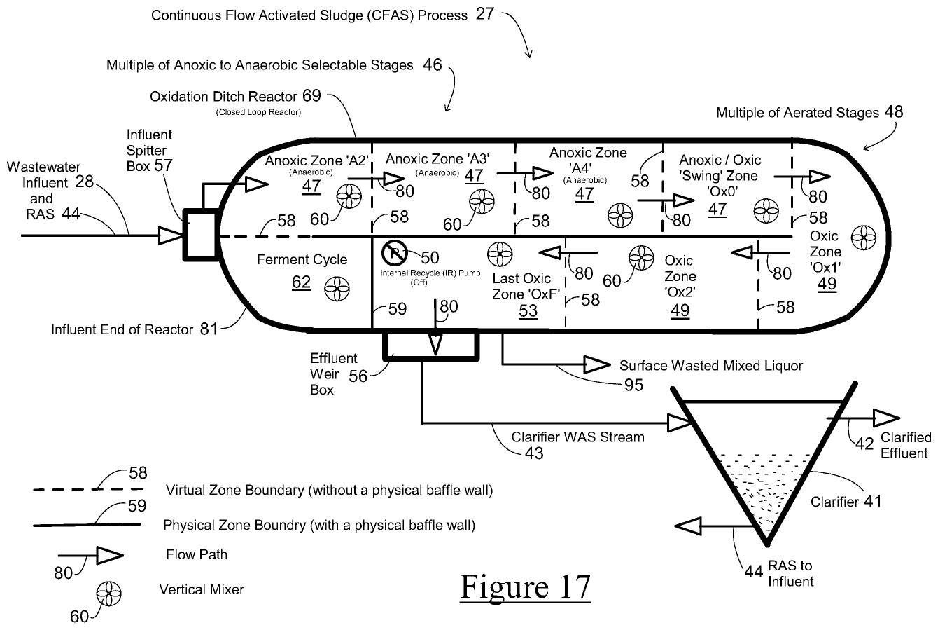

FIGS. 13 through 16 illustrate how the transition from the conventional EBPR 23 process to the AGS 31 process would occur in an oxidation ditch reactor 69, utilizing the Phosphorus and Nitrogen Removal System 30 of the present invention, similar to what was described previously for a compartmentalized plug-flow reactor to process the activated sludge 25. FIG. 13 depicts an initial start-up step in which the internal recycle from Ox3 is directed to one of the first anoxic stages as necessary to develop PAOs in the system in the oxidation ditch reactor embodiment of the present invention. FIG. 14 depicts a second step, in which a transition sequence begins that begins a transition sequence in which the internal recycle from the Ox3 is directed to one of the next anoxic stages, while creating conditions that allow for the development of some AGS and in turn provides for a reduction in the internal recycle flow rate in the oxidation ditch reactor embodiment of the present invention. FIG. 15 depicts a third step that continues the transition sequence in which the internal recycle from Ox3 is directed to one of the next anoxic stages, which allow for additional and continuing development of some AGS, and in turn provides for a further reduction in the internal recycle flow rate in the oxidation ditch rector embodiment of the present invention. FIG. 16 depicts a forth step that continues the transition sequence to the point at which the internal recycle from Ox3 can be turned off, allowing for the continuing development of some AGS in the oxidation ditch reactor embodiment of the system of the present invention. FIG. 17 depicts a schematic diagram showing how one of the multiple of anoxic to anaerobic selectable stages 46 in the oxidation ditch reactor 69 configuration as shown can be isolated to allow for densified settled bed fermentation 64 of the suspended solids in the activated sludge 25. The isolation of one anaerobic zone in the oxidation ditch reactor provides for implementation of the fermentation cycle within the stage of the reactor, with the ferment cycles able to begin concurrently with the start up and transition sequences discussed above, and then continue indefinitely thereafter.

Again, the Phosphorus and Nitrogen Removal System 30 of the present invention can be applied to new and existing activated sludge process configurations to achieve an improved EBPR 23 system, and especially in those existing systems designed and operated to support the development of AGS 31. The above technical description of the innovations of the present invention is by way of example, however, it should be noted that other similar process configurations could be utilized in applying this method. For instance, FIGS. 4 through 11 show process schematics of preferred embodiments of the present invention scaled to provide the benefits of the present invention at a relatively smaller municipal and industrial waste water treatment plant (WWTP).

A most preferred embodiment of the Phosphorus and Nitrogen Removal System 30 of the present invention includes employing the microprocessor-based controller 70, which provides for and enables automatic, accurate and precise execution and control of the system's process as embodied in the process control algorithm 71. Specific process variables input to the microprocessor-based controller for use in the process control algorithm for the system, preferably include the telemetered measurement of the ORP or the rbCOD, liquid level sensors, and liquid solids interface sensors as process variable inputs to automate ferment cycles to optimize the EBPR 23 process.

For this Detailed Description of Specific Embodiments, the terms “connected”, “attached”, “coupled” and “mounted” refer to any form of interaction between two or more elements, including mechanical, electrical, magnetic, electromagnetic, fluid, and thermal interaction. Two components may be functionally coupled with or to each other, even though they are not in direct contact with each other.

Also, the terms “substantially”, and “approximately” or “approximate” are employed herein throughout, including this detailed description and the attached claims, with the understanding that is denotes a level of exactitude commensurate with the skill and precision typical for the particular field of endeavor, as applicable.

Additionally, the terminology used in this Detailed Description of Specific Embodiments is to be interpreted according to ordinary and customary usage in the field of the invention as exemplified in the pertinent U.S. and International Patent Classification Codes, and equivalent codes in other patent classification systems.

The word “embodiment” is used herein to mean “serving as an example, instance, or illustration.” Any embodiment described herein is not necessarily to be construed as preferred or advantageous over other embodiments. While the various aspects of the embodiments are presented in drawings, the drawings are not necessarily drawn to scale.

Additionally, reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that the above Detailed Description of Specific Embodiments includes the referenced figures and following claims, and is more simply referred to herein as the “description” or the “disclosure.” In this description, various features are sometimes grouped together in a single embodiment, figure, or written explanation thereof for the purpose of streamlining this disclosure. However, this method of disclosure is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this description are hereby expressly incorporated into this description and disclosure, with each claim standing on its own as a separate embodiment. This description includes all permutations of the independent claims with their dependent claims.

In compliance with the statutes, the invention has been described in language more or less specific as to structural features and process steps where applicable. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

What is claimed is:

1. A phosphorus and nitrogen removal system for use in treatment of an activated sludge wastewater, said phosphorus and nitrogen removal system comprising:
a plurality of compartmentalized tanks initially with a multiple of anoxic to anaerobic selectable stages followed by a multiple of aerated stages;
an internal recycle pump that pumps the activated sludge wastewater from a last aerated stage of the multiple of aerated stages, the activated sludge wastewater discharged from the internal recycle pump and selectively fed into to any one of the multiple of anoxic to anaerobic selectable stages; and
an operational transition for the phosphorus and nitrogen removal system, from a flocculent producing activated sludge enhanced biological phosphorus removal system to a densified activated sludge enhanced biological phosphorus removal system, in which a production of an aerobic granular sludge predominates and in which a simultaneous nitrification and denitrification within the aerobic granular sludge eliminates the need for internal recycle from an aerated zone to an anoxic zone of the multiple of anoxic to anaerobic selectable stages, and a stepwise conversion of a first anoxic stage in a flow sequence within the plurality of compartmentalized tanks to an anaerobic zone by a change in discharge location of the internal recycle into a next anoxic stage in the flow sequence, together with a decrease in a rate of the recycle flow.

2. The phosphorus and nitrogen removal system of claim 1, additionally including:
a recycle splitter box that discharges the internal recycle from the internal recycle pump to in feed selectively into any one of the multiple of anoxic to anaerobic selectable stages.

3. The phosphorus and nitrogen removal system of claim 1, additionally including:
an overflow weir located between each of the multiple of anoxic to anaerobic selectable stages, and the multiple of anoxic to anaerobic selectable stages operable selectively in either a series stage of operation or in a parallel stage of operation;
the overflow weir each closable between the selector stages to isolate one or more of the selector stages for a quiescent settling of the activated sludge wastewater, to form a dense settled bed and to remain in the quiescent settling long enough for a fermentation within the dense settled bed to occur; and
a waste activated sludge withdrawn from a surface of the last aerated stage, with a constant depth maintained over the weir, with said depth maintained at a shallow level such that the waste activated sludge is withdrawn as a laminar liquid flow across a liquid surface of the last aerated stage.

4. The phosphorus and nitrogen removal system of claim 3, additionally wherein:
a programmable logic controller or other microprocessor-based monitoring and control system, controls the operational sequencing and elevation of the automated downward opening weirs between each of the selector stages when effecting a series of stepwise changes in the operational transition for the phosphorus and nitrogen removal system, from a flocculent producing activated sludge enhanced biological phosphorus removal system to a densified activated sludge enhanced biological phosphorus removal system;
the programmable logic controller or other microprocessor-based monitoring and control system, controls the operational sequencing and elevation of the automated downward opening weirs between the desired selector stages when effecting the isolation of one or more selector stages to create fermentation conditions in the settled mixed liquid bed during a ferment cycle; and
a control of a crest over the automated downward opening weir in the last aerated stage to a desired setpoint for removing waste activated sludge from the surface of said last aerated stage.

5. The phosphorus and nitrogen removal system of claim 1, wherein the a transition step in the operational transition for the phosphorus and nitrogen removal system, from a flocculent producing activated sludge enhanced biological phosphorus removal system to a densified activated sludge enhanced biological phosphorus removal system is initiated when a predetermined concentration of nitrate plus nitrate in the last aerated zone has been reached.

6. The phosphorus and nitrogen removal system of claim 4, wherein a transition step in the operational transition for the phosphorus and nitrogen removal system, from a flocculent producing activated sludge enhanced biological phosphorus removal system to a densified activated sludge enhanced biological phosphorus removal system is initiated when a predetermined concentration of nitrate plus nitrate in the last aerated zone has been reached as measured by a sensor located in the last aerated stage and recorded the programmable logic controller or other microprocessor-based monitoring and control system.

7. The phosphorus and nitrogen removal system of claim 1, wherein a transition step in the operational transition for the phosphorus and nitrogen removal system, from a flocculent producing activated sludge enhanced biological phosphorus removal system to a densified activated sludge enhanced biological phosphorus removal system is initiated based on an observation of a mixed liquor, with use of a stereomicroscope to observe a size distribution and an abundance of an aerobic granule within the aerobic granular sludge.

8. The phosphorus and nitrogen removal system of claim 1, wherein a transition step in the operational transition for the phosphorus and nitrogen removal system, from a flocculent producing activated sludge enhanced biological phosphorus removal system to a densified activated sludge enhanced biological phosphorus removal system is initiated based on simultaneous measurements of a nitrate concentration, a nitrite concentration, and an ammonia concentration, as taken in each of the multiple of aerated stages.

9. The phosphorus and nitrogen removal system of claim 1, wherein a transition step in the operational transition for the phosphorus and nitrogen removal system, from a flocculent producing activated sludge enhanced biological phosphorus removal system to a densified activated sludge enhanced biological phosphorus removal system is initiated automatically based on simultaneous online sensor measurements of nitrate, nitrite, and ammonia in each of the aerated stages and input into a programmable logic controller or other microprocessor-based monitoring and control system.

10. The phosphorus and nitrogen removal system of claim 1, wherein a defined ferment cycle continues until a predetermined period of time has elapsed, an oxidation-reduction potential measurement in the settled mixed liquor bed has reached a predetermined setpoint.

11. The phosphorus and nitrogen removal system of claim 1, wherein a defined ferment cycle continues until a predetermined period of time has elapsed, the second derivative of the rate of change of the oxidation-reduction potential measurement in the settled bed has reached a predetermined setpoint.

12. The phosphorus and nitrogen removal system of claim 1, wherein a defined ferment cycle continues until the output of a readily biodegradable carbon substrate bioelectrode sensor located in settled mixed liquor bed has reached a predetermined setpoint.

13. The phosphorus and nitrogen removal system of claim 1, wherein a defined ferment cycle continues until the output of a readily biodegradable carbon substrate bioelectrode sensor located in settled mixed liquor bed has reached a predetermined setpoint and a predetermined oxidation-reduction potential measurement has been reached.

14. The phosphorus and nitrogen removal system of claim 1, wherein a defined ferment cycle continues until the output of a readily biodegradable carbon substrate bioelectrode sensor located in settled mixed liquor bed has reached a predetermined setpoint or value and a predetermined second derivative of the rate of change of the oxidation-reduction potential measurement has been reached.

15. The phosphorus and nitrogen removal system of claim 1, additionally with an external tank together with an associated pumping and piping systems for a fermentation of the mixed liquor or the return activated sludge, in addition to or instead of an in-line fermentation in an isolated anaerobic stage or in an isolated anoxic stage.

16. A phosphorus and nitrogen removal system comprising:
an elongated closed loop reactor, including a multiple of anaerobic to anoxic selectable stages and a multiple of aerated stages, constructed and operated with a mixing system that mixes vertically to form an equivalent of a compartmentalized stage, without the use of a physically partitioning baffle between the multiple of anaerobic to anoxic selectable stages and the multiple of aerated stages in the elongated closed loop reactor;
an internal recycle pump that pumps an internal recycle stream of activated sludge from a last aerated stage of the multiple of aerated stages to a system of piping and valves for discharge from the internal recycle pump to be selectively conveyed to any of the multiple of anaerobic to anoxic selectable stages;
a splitter box with an automated gate to each of the multiple of anaerobic to anoxic selectable stages to be isolated to allow for quiescent settling of the mixed liquor to form a dense settled bed and to remain in this state long enough for fermentation within the settled bed to occur;
withdrawal of a waste activated sludge from a surface of the last aerated stage using and automated downward opening weir to maintain a relatively constant depth over the weir where said depth is maintained at a shallow level such that the waste activated sludge is withdrawn as a laminar flow of liquid across the surface of the last aerated stage;
an operation and control strategy for a stepwise transition in the multiple of anaerobic to anoxic selectable stages and the multiple of aerated stages, from a flocculent activated sludge enhanced biological phosphorus removal system to a densified activated sludge system that produces an aerobic granular sludge, with simultaneous nitrification and denitrification, and eliminates the internal recycle from the aerated zone to the anoxic zone; and
with conversion of the first anoxic stage in the sequence of flow within the multiple of anaerobic to anoxic selectable stages to an anaerobic zone, by changing the infeed location of the internal recycle discharge into the next multiple of anaerobic to anoxic selectable stages in sequence, together with a commensurate decrease in a infeed flow rate of the internal recycle.

17. The phosphorus and nitrogen removal system of claim 16, wherein an external tank together with associated pumping and piping systems is utilized to provide for fermentation of mixed liquor or return activated sludge either in addition to in-line fermentation in an isolated anaerobic or anoxic stage, or instead of in-line fermentation in an isolated anaerobic or anoxic stage.

18. The phosphorus and nitrogen removal system of claim 16, wherein the vertical mixing system within the anaerobic and anoxic zones is a compressed gas and low pressure air with large bubble mixing that does not produce a horizontal flow condition.

19. The phosphorus and nitrogen removal system of claim 16, wherein the aerobic zones includes the vertical mixing system with a compressed gas and low pressure air with large bubble mixing that does not produce a horizontal flow condition in addition to a fine bubble diffused aeration.
